(19) United States
(12) Patent Application Publication
(10) Pub. No.: US 2023/0001244 A1
(43) Pub. Date: Jan. 5, 2023

(54) EMERGENCY RESPONSE VEHICLE

(71) Applicant: Electricwaze LLC, Wilmington, DE (US)

(72) Inventor: Ross Tessien, Grass Valley, CA (US)

(21) Appl. No.: 17/779,117

(22) PCT Filed: Nov. 23, 2020
(86) PCT No.: PCT/US2020/061802

§ 371 Date: May 23, 2022

Related U.S. Application Data
(60) Provisional application No. 62/939,223, filed on Nov. 22, 2019.

(51) Int. Cl. A62C 27/00; A62C 31/28

(52) U.S. Cl. CPC A62C 27/00; A62C 31/28

(57) ABSTRACT

A zero-emissions emergency response vehicle includes at least one zero-emissions power system; at least one drive assembly coupled to the at least one zero-emissions power system and operable to move the vehicle with power from the at least one zero-emissions power system; and at least one ultra-high pressure (UHP) fluid delivery system mounted to the vehicle. The at least one UHP fluid delivery system includes a fluid reservoir mounted to the vehicle and configured to store a fire-suppression fluid, a fluid output tool fluidly coupled to the fluid reservoir, and at least one UHP pump-motor assembly coupled to the at least one zero-emissions power system and operable to circulate a flow of the fire-suppression fluid from the fluid reservoir to the fluid output tool with power from the at least one zero-emissions power system.

### TECHNICAL FIELD

This disclosure relates to emergency response vehicles and more particularly vehicles for rescuing trapped people and for suppressing a fire using ultra-high pressure fluid flow.

### BACKGROUND

Emergency vehicles, such as firefighting vehicles, often are required to travel to emergencies, such as fires, and include equipment to extinguish or try to extinguish a fire.

### SUMMARY

The present disclosure describes an emergency response vehicle, such as a firefighting vehicle system included of a vehicle and at least one and preferably four ultra-high pressure (UHP) fluid containing fluid delivery systems. Each system is included of a high pressure pump connected to a fluid reservoir on one side and a high pressure fluid line on the other side. Preferably at least one high pressure line runs to a position forward of the driver of the vehicle. There, each of the high pressure line(s) connects to a reel of high pressure hydraulic line and the line is further connected to a spray wand. The emergency response vehicle, in some embodiments, includes technologies to enable it to address emergencies within oxygen deprived tunnel environments. One preferable option is to include air hoses within the crew cab so that crew can connect to the vehicle air supply while driving into a smoke filled tunnel like environment.

In an example implementation, a zero-emissions emergency response vehicle includes at least one zero-emissions power system; at least one drive assembly coupled to the at least one zero-emissions power system and operable to move the vehicle with power from the at least one zero-emissions power system; and at least one ultra-high pressure (UHP) fluid delivery system mounted to the vehicle. The at least one UHP fluid delivery system includes a fluid reservoir mounted to the vehicle and configured to store a fire-suppression fluid, a fluid output tool fluidly coupled to the fluid reservoir, and at least one UHP pump-motor assembly coupled to the at least one zero-emissions power system and operable to circulate a flow of the fire-suppression fluid from the fluid reservoir to the fluid output tool with power from the at least one zero-emissions power system.

In an aspect combinable with the example implementation, the at least one UHP pump-motor assembly is electrically coupled to the zero-emissions power system to directly receive electrical power from at least one electrical power storage device of the at least one zero-emissions power system.

In another aspect combinable with any of the previous aspects, the at least one electrical power storage device includes a battery.

In another aspect combinable with any of the previous aspects, the UHP fluid delivery system further includes a UHP fluid line pressure control system configured to perform operations including modulating rotational speed of a motor of the at least one UHP pump-motor assembly to maintain a predetermined fluid line pressure.

In another aspect combinable with any of the previous aspects, the UHP fluid line pressure control system is configured to perform operations further including determining that a fluid line pressure of the fire suppression fluid is less than the predetermined fluid pressure; and based on the determination, increasing the rotational speed of the motor up toward a maximum allowable rotational speed of the motor.

In another aspect combinable with any of the previous aspects, the UHP fluid line pressure control system is configured to perform operations further including determining that a fluid line pressure of the fire suppression fluid is greater than the predetermined fluid pressure; and based on the determination, decreasing the rotational speed of the motor down toward, and inclusive of, zero rpm.

Another aspect combinable with any of the previous aspects further includes at least one switch positioned in the vehicle and communicably coupled to the at least one UHP fluid delivery system, the at least one switch adjustable between an off position to de-energize the UHP pump-motor assembly and an on position to energize the UHP pump-motor assembly.

In another aspect combinable with any of the previous aspects, the at least one switch is operable in the on position to energize the UHP pump-motor assembly independent of operation of the at least one drive assembly.

In another aspect combinable with any of the previous aspects, the at least one switch is located on a portable remote control.

Another aspect combinable with any of the previous aspects further includes a human-occupiable crew cab.

In another aspect combinable with any of the previous aspects, the at least one UHP fluid delivery tool is stowed on the vehicle forward of the crew cab.

In another aspect combinable with any of the previous aspects, the at least one UHP fluid delivery system further includes a hose reel coupled to the fluid outlet tool, the hose reel positioned on the vehicle forward of the crew cab.

Another aspect combinable with any of the previous aspects further includes a vision system configured to perform operations including detecting one or more objects located near to the vehicle; and providing a visual indication of the detected one or more objects within the crew cab.

In another aspect combinable with any of the previous aspects, the vision system includes an infrared camera.

In another aspect combinable with any of the previous aspects, the vision system further includes one or more infrared illuminating lights operable to emit infrared light away from the vehicle.

In another aspect combinable with any of the previous aspects, the emitted light is at a light center wavelength greater than 650 nm.

In another aspect combinable with any of the previous aspects, the vision system includes at least one ultrasonic transceiver configured to determine a distance between the vehicle and at least one external object.

Another aspect combinable with any of the previous aspects further includes a human-breathable compressed air system in fluid communication with the hose reel.

In another aspect combinable with any of the previous aspects, the hose reel includes a hose pair that includes a first hose that communicates the fire suppression fluid from the fluid reservoir to the fluid output tool; and a second hose that communicates a pressurized human-breathable gas from the human breathable compressed air system to an output located near the fluid output tool.

In another example implementation, an emergency response vehicle includes a vehicle drive system that includes one or more wheels driveably coupled to an engine; at least one zero-emissions power system mounted to the vehicle; and at least one ultra-high pressure (UHP) fluid delivery system mounted to the vehicle and including a fluid reservoir mounted to the vehicle and configured to store a fire-suppression fluid, a fluid output tool fluidly coupled to the fluid reservoir, and at least one UHP pump-motor assembly the fluid pump driven by a motor coupled to the at least one zero-emissions power system and operable to circulate a flow of the fire-suppression fluid from the fluid reservoir to the fluid output tool with power from the at least one zero-emissions power system.

In an aspect combinable with the example implementation, the engine includes an internal combustion engine.

In another aspect combinable with any of the previous aspects, the engine includes a generator electrically coupled to the at least one zero-emissions power system to electrically charge at least one electric power storage device of the at least one zero-emissions power system.

In another aspect combinable with any of the previous aspects, the at least one electrical power storage devices includes an electrical energy storage battery.

In another aspect combinable with any of the previous aspects, the UHP fluid delivery system further includes a UHP fluid line pressure control system configured to perform operations including modulating a rotational speed of a motor of the at least one UHP pump-motor assembly to maintain a predetermined fluid line pressure

In another aspect combinable with any of the previous aspects, the UHP fluid line pressure control system is configured to perform operations further including determining that a fluid line pressure of the fire suppression fluid is less than the predetermined fluid pressure; and based on the determination, increasing the rotational speed of the motor up toward a maximum allowable rotational speed of the motor.

In another aspect combinable with any of the previous aspects, the UHP fluid line pressure control system is configured to perform operations further including determining that a fluid line pressure of the fire suppression fluid is greater than the predetermined fluid line pressure; and based on the determination, decreasing the rotational speed of the motor down toward, and inclusive of, zero rpm.

Another aspect combinable with any of the previous aspects further includes at least one switch positioned in a human-occupiable crew cab on the vehicle and communicably coupled to the at least one UHP fluid delivery system, the at least one switch adjustable between an off position to de-energize the UHP pump-motor assembly and an on position to energize the UHP pump-motor assembly.

In another aspect combinable with any of the previous aspects, the at least one switch is operable in the on position to energize the UHP pump-motor assembly independent of operation of the at least one vehicle drive system.

In another aspect combinable with any of the previous aspects, the at least one switch is located on a portable remote control.

In another aspect combinable with any of the previous aspects, the at least one UHP fluid delivery tool is stowed on the vehicle forward of the crew cab.

In another aspect combinable with any of the previous aspects, the at least one UHP fluid delivery system further includes a hose reel coupled to the fluid outlet tool, the hose reel positioned on the vehicle forward of the crew cab.

Another aspect combinable with any of the previous aspects further includes a vision system configured to perform operations including detecting one or more objects located near to the vehicle; and providing a visual indication of the detected one or more objects within the crew cab.

In another aspect combinable with any of the previous aspects, the operation of detecting the one or more objects includes detecting the one or more objects using a light wavelength that is outside a human-visible light wavelength range.

In another aspect combinable with any of the previous aspects, the vision system further includes one or more illuminating lights operable to emit light away from the vehicle at a center wavelength longer than 650 nm.

In another aspect combinable with any of the previous aspects, the vision system further includes at least one ultrasonic transceiver configured to determine a distance between the vehicle and at least one external object.

Another aspect combinable with any of the previous aspects further includes a human-breathable compressed air system in fluid communication with the hose reel.

In another aspect combinable with any of the previous aspects, the hose reel includes a hose pair that includes a first hose that communicates the fire suppression fluid from the fluid reservoir to the fluid output tool; and a second hose that communicates a pressurized human-breathable gas from the human breathable compressed air system to an output located near the fluid output tool.

In another example implementation, an emergency response vehicle includes a human-occupiable crew cab mounted to a chassis; a vehicle drive system mounted to the chassis and including one or more wheels driveably coupled to a vehicle power system that includes an internal combustion engine; at least one fluid reservoir mounted to the vehicle and configured to store a fire-suppression fluid; at least one ultra-high pressure (UHP) fluid delivery system mounted to the chassis, the at least one UHP fluid delivery system including a fluid output tool fluidly coupled to the at least one fluid reservoir, and at least one UHP pump-engine assembly operable to circulate a flow of the fire-suppression fluid from the fluid reservoir to the respective fluid output tool via power provided by an internal combustion engine to drive the fluid pump; and at least one switch positioned in the crew cab and communicably coupled to at least one of the at least one UHP fluid delivery systems, the at least one switch adjustable between an off position to de-energize at least one of the UHP pump-engine assemblies and an on position to energize the at least one of the UHP pump-engine assemblies independent of operation of the vehicle power system.

In an aspect combinable with the example implementation, the at least one switch is located on a portable remote control.

In another aspect combinable with any of the previous aspects, at least one of the UHP fluid delivery tools is positioned on the vehicle forward of the crew cab.

In another aspect combinable with any of the previous aspects, each of the at least one UHP fluid delivery systems further includes a hose reel and fluid hose coupled to the fluid outlet tool, and where the hose reel is positioned on the vehicle forward of the crew cab.

Another aspect combinable with any of the previous aspects further includes a human-breathable compressed gas system in fluid communication with the hose reel.

In another aspect combinable with any of the previous aspects, the hose reel includes a hose pair that includes a first hose that communicates the fire suppression fluid from the fluid reservoir to the fluid output tool; and a second hose that communicates a pressurized human-breathable gas from the human breathable compressed gas system to an output located near the fluid output tool.

In another example implementation, an emergency response vehicle includes a human-occupiable crew cab mounted to a chassis; a vehicle drive system mounted to the chassis and including one or more wheels driveably coupled to a vehicle power system; at least one fluid reservoir mounted to the vehicle and configured to store a fire-suppression fluid; at least one ultra-high pressure (UHP) fluid delivery system mounted to the chassis, the at least one UHP fluid delivery system including a fluid output tool fluidly coupled to the at least one fluid reservoir, and at least one UHP pump-assembly operable to circulate a flow of the fire-suppression fluid from the fluid reservoir to the respective fluid output tool via power provided by one of an engine or a motor to drive the fluid pump; and at least one directable turret mount, mounted onto the vehicle and configured to securely hold the fluid output tool independent of vehicle movement and independent of whether the tool is or is not spraying the fire suppression fluid, and where the turret mount is included of a fluid output tool latch that is hand operable to securely hold the fluid output tool onto the vehicle when latched, and to release the fluid output tool for removal by hand when the latch is unlatched, and at least one turret controller that controls the turret pointing of the turret and the flow of fire suppression fluid through the fluid output tool when mounted onto the turret.

In an aspect combinable with the example implementation, the turret mount includes a detent to lock the fluid output tool hand valve in the open position while the fluid output tool is mounted onto the turret.

In another aspect combinable with any of the previous aspects, the turret mount includes an electro-mechanical switch that is electrically changed from a first electrical condition when the fluid output tool is mechanically removed from the turret to a second electrical condition when the fluid output tool is mechanically installed and latched onto the turret

In another aspect combinable with any of the previous aspects, the electro-mechanical switch is in electrical communication with the at least one UHP fluid delivery system.

In another aspect combinable with any of the previous aspects, the turret control is in electrical communication with the UHP fluid delivery system and where the UHP pump assembly varies the fluid flow through the fluid output tool based on a signal received from the turret control.

### BRIEF DESCRIPTION OF THE DRAWINGS

FIG. 1 shows a schematic illustration of a fire suppression system of an emergency response vehicle.

FIG. 2 shows a side elevation view of an example embodiment of an emergency response vehicle.

FIG. 3 shows a top plan view of an example embodiment of an emergency response vehicle.

FIG. 4 shows an example on off switch located within the crew cab with controls to control up to 4 UHP pump systems

FIG. 5 shows a view of a fire fighter breathing apparatus and a fire suppression tool including a dual hose reel configuration. The breathing apparatus is shown with hoses delivering breathable air from a bottle carried by the fire crew.

FIG. 6 shows a similar view as shown in FIG. 5, except that the air line from the fire truck vehicle is connected to provide air from the emergency response vehicle air bottle rather than air being provided from the portable air bottle.

FIG. 7 shows how the fire suppression tool can be inserted through a hole in a wall from a safe location into a fully engulfed fire space.

FIG. 8 shows an exemplary remote control including turret joy stick and up to 4 UHP fluid system on off switches.

FIGS. 9 and 10 each show an elevation view of an exemplary fire vehicle fitted with an emitter and detector capable of detecting objects ahead of the vehicle and displaying them on an interior monitor.

FIG. 11 shows how a single reel with a double hose system can couple both breathable air and fire suppression fluid into the hose reel and into individual hoses, provided to the fire crew as a pair of hoses, one delivering fluid, e.g., water and the other delivering breathable air from the fire vehicle tank(s)

FIG. 12 shows one embodiment for how to lock the fire suppression tool onto a turret and how the tool trigger is locked into the “On” condition with the trigger pulled while mounted onto the turret. It also shows an elevation view of the fire suppression tool mounted onto the turret.

### DETAILED DESCRIPTION

Emergency response vehicles for fighting fires are ubiquitous worldwide. Typically they deliver fluid to a fire through a 1.5 to 2.5 inch hose and smooth bore nozzles at a pressure around 100 psi and a flow rate around 150 gpm and higher. These specifications are prescribed by, for example, the National Fire Protection Association (NFPA) within the U.S. Ultra-high pressure (UHP) is currently defined by the NFPA to be fluid spray delivery at a pressure higher than 1,100 psi (e.g., http://hmafire.com/what-is-uhp). In the present disclosure, UHP will be taken to be fluid or fluid spray pressurized to more than 1,100 psi after the high pressure pump, or higher.

The present disclosure describes an emergency response vehicle as a primary structure fire attack vehicle that exceeds performance at suppressing a fire, at a lower cost and with a lower fluid requirement to suppress a typical fire. UHP systems can suppress a fire using one tenth to one fifth of the fluid typically needed by common fire engines that deliver fluid from hoses at around 150 gpm. It is an object of the present disclosure to develop a superior fire vehicle that knocks down a fire solely using UHP fluid (typically fluid or fluid foam) delivery and which does so using a fraction of the fluid requirements of a typical standard fire engine.

To accomplish this it will be necessary to better understand how UHP fire suppression works so that the best method of using UHP systems becomes illuminated. Currently, UHP is poorly studied and even advocates make the mistake of thinking that UHP functions by absorbing heat better than smooth bore fluid delivery. While it is true that a larger percentage of fluid is vaporized when droplets are smaller, a larger droplet still removes more heat. UHP, counter to popular thinking, does not function by heat removal as does a conventional 150 gpm fire hose. UHP functions by suffocating a fire and this requires a completely different method of using UHP fluid delivery. The existing UHP systems fail to deliver fluid in a best manner for rapid fire suppression. This inadequacy stems from a mistaken belief that UHP fluid delivery functions primarily by removing heat.

Considering the thermodynamics of a fire, it is clear that heat absorption as suggested by UHP advocates is not the fire suppression mechanism involved. Based on heat absorption, a fire would be growing at almost as if the spray were not being delivered. The oxidation process in flames shuts down when the oxygen concentration falls below 15%. Normal atmospheric oxygen concentration is 21%. And it takes approximately six seconds of fluid vaporization at a flow of 20 gpm to displace enough oxygen to below 15%. Clearly, oxygen starvation is the mechanism involved.

Whereas it takes a while to get fluid onto all of the hot material in a room to cool the materials down, working against a 20 MW HRR, it only takes six seconds to shut down a 20 MW HRR by displacing oxygen using fluid vapor as the oxygen dispersant. Fluid vapor in a hot fire environment has a volume approximately 2,000 times greater than the fluid droplets that vaporize.

Flowing fluid, e.g., water, at 20 gpm for 6 seconds into a hot environment will yield approximately 535 cubic feet of fluid vapor. This is enough to drop the oxygen concentration within a 2 car garage to below 15%. This means that a UHP system at 20 gpm can turn off the 15 MW HRR in six seconds if applied correctly so as to starve the fire of oxygen. The flames turn off almost immediately and once the HRR is dropped to zero, then the 2 MW cooling power of the fluid mist cools the contents of the structure to below ignition temperature. This uses just 60 total seconds of fluid flow, or, about 20 gallons of fluid.

Another problem with current fire and rescue vehicles comes in the rare circumstances of an intense fire in a roadway conduit tunnel. When an intense fire is initiated within the confined space of a tunnel, the fire rapidly consumes the available oxygen down to around 15% oxygen concentration (normal atmospheric oxygen concentration is 21%) and emits copious quantities of dense smoke. Visibility can be less than six inches when the soot is thick.

The problem with this is that normal fire trucks running on a diesel Internal Combustion Engine (ICE) will stall out and be disabled in the thick smoke and low oxygen environment. Not only can an internal combustion engine to move the vehicle not run in such an environment, but the same engine or a separate engine is used to drive any fluid pumps, UHP or normal pressure alike. Those engines also fail to operate once the oxygen drops too low in the confined tunnel environment. As a result, if the fire grows beyond a limit, normal fire rescue vehicles are completely useless within a tunnel filled with thick smoke during a somewhat rare incident such as the Mont Blanc and other tunnel fires where numerous people have been killed and fire fighters were unable to reach and rescue victims or to suppress the blaze. In these incidents, the rescue and fire suppression attempts are abandoned and anyone unlucky enough to be trapped inside will die and, as was the case for the Mont Blanc and other fires, become incinerated. It is therefore literally a matter of life and death to create a new vehicle capable of operating within the oxygen deprived environment of tunnels during tunnel fires. This is especially the case given that efforts are being made to develop long distance roadway conduits for transportation such as U.S. Pat. No. 10,145,241 to Tessien.

Beyond tunnel fires, there exists today a significant time delay between when a 911 distress call is made and when fluid begins to flow on a fire. This time delay is the sum of several small delays that are themselves compromises based on available technologies. These delays are comprised of the following times for: 1) The staff to be signaled and to get into a vehicle and depart the station; 2) Drive to the incident scene; 3) Deploy hoses; 4) Deploy hose to connect to fire hydrant.

With respect to these time durations: 1) The time to get staff into the vehicle and to get the vehicle out of the station is fairly fixed and already optimized reasonably well; 2) It is well known that a smaller vehicle can get to the scene faster. Depending on the distance to the scene, the average time difference is perhaps two minutes. In fire scene videos, the Chief often arrives in a small pickup truck a couple minutes before the engines arrive. The chief makes a walk around the incident structure and radios to arriving engines where they can find hydrants and which roads to follow to bring the fire engines into the scene; 3) It is known that it is faster to deploy a charged hose on a reel than it is to deploy “lay flat” canvas hose which must be charged following firing up the fluid pump on the fire engine. This process can take two minutes, whereas deploying a hose from a reel can take five seconds; 4) A fire engine carries about 500 gallons of fluid and a single hose shoots about 150 gallons of fluid. This means that fire fighters have three minutes of fluid delivery before the engine is out of fluid. If a fire hydrant is close by the fire scene, this is often enough time to get a hydrant connected so that fluid delivery is not interrupted. However, as is often the case, the primary engine will run out of fluid and fire fighters will stand in front of a burning house or building, waiting for new fluid to be supplied. Entire homes have been lost this way.

The present disclosure describes embodiments of an emergency response vehicle that achieves time savings to reach a fire in the four to 6 minute range in rural areas. This time savings is the sum of about two minutes transit time, two minutes hose deployment time, and a lack of need to connect to a hydrant because UHP systems consume one fifth to one tenth the fluid of a typical fire engine. An average rural call may save five minutes from when the emergency call is placed to when the first fluid is delivered onto the fire. The fire growth in five minutes can often make the difference between the contents of a garage being burnt to the entire home being destroyed.

The present disclosure also describes embodiments of an emergency response vehicle that replaces typical fire engines for fires in tunnels where ICE-powered vehicles and fluid pumps often cannot operate, and, for fires of typical structures where the reduced time to deploy first fluid is afforded in a smaller vehicle capable of completely suppressing the entire fire with the same or better ability as is provided by a normal fire engine.

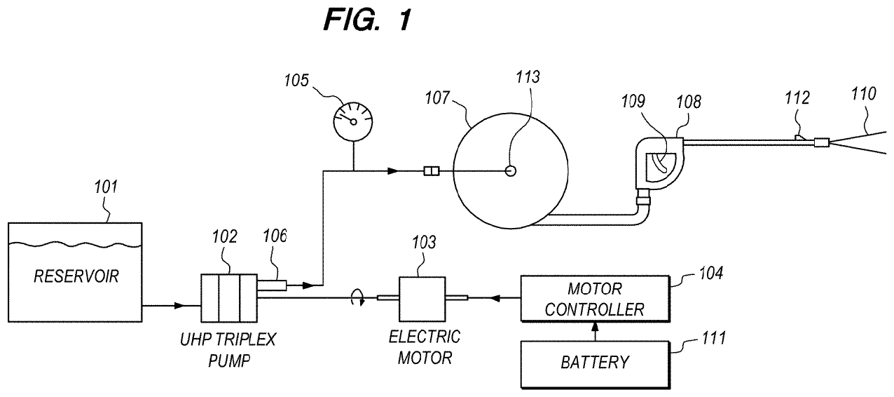

In FIG. 1 the core properties of the emergency response vehicle are shown. We see the reservoir of water 101 or fire suppression fluid. The reservoir is in fluid communication with the ultra-high pressure, UHP, triplex pump 102. There are other pump types that are able to produce the required ultra-high pressure so that using a triplex pump is but one possible pump choice. The electric motor 103 is a zero emissions motor. But the motor could be air powered, or it could be a gas engine for applications that do not use a zero emissions system.

The motor controller 104 can follow the line pressure, the line pressure indicated by the pressure gauges 105 on the line output 106 to the hose reel 107 and then to the fire suppression tool 108, or wand, used to spray the fluid into a burning structure. The output tool is equipped with a hand actuated valve 109 to turn the flow on and off as desired. Preferably, for the electric zero emissions variant of the system, a battery energy storage 111 will be on board and will provide the energy to drive the motor that turns the UHP fluid pump.

Typically, the fire suppression fluid will be simply water. This is because the UHP system preferably functions by vaporization, which removes heat and displaces oxygen. While foaming agents can be used, they are not as important as they are when using 150 gpm low pressure system where the vast majority of the water falls to the floor and is not useful in suppressing the fire. In those systems, adding a foaming agent helps the water to cling to the materials in the room rather than simply fall to the ground. This function is not required when one is working to displace the oxygen to rapidly shut down the heat release rate, rather than trying to cool the burning materials.

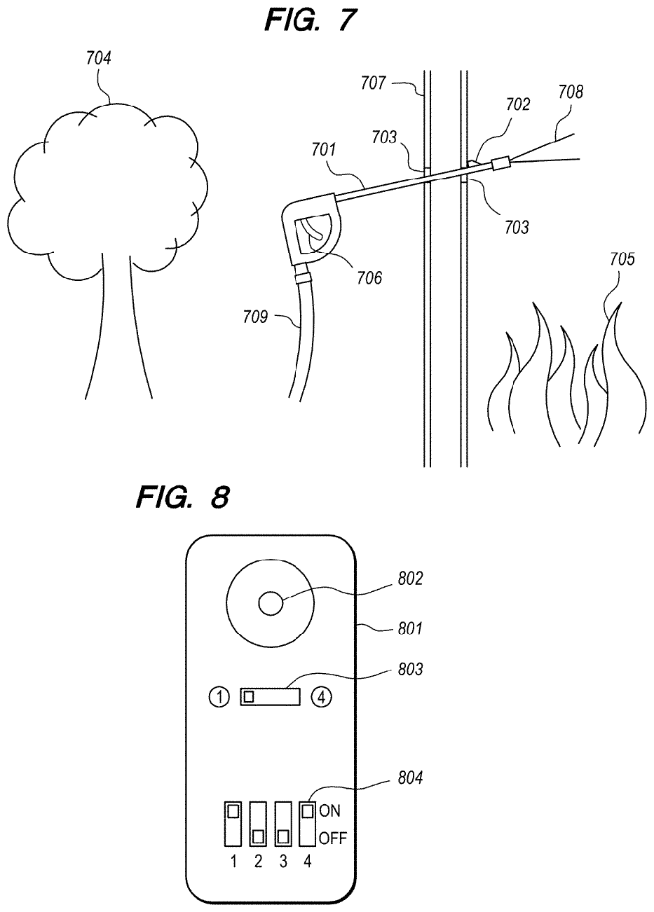

Shown on the end of the fire suppression tool is a small catch feature 112 similar to a sight on a rifle. That feature is a functional addition for use during insertion of the wand into a structure through a hole in an exterior or other wall. By piercing a small hole through a wall from a safe location into a fully involved compartmental fire room (shown in FIG. 7), the wand tip can be inserted into the dangerous environment from a safe environment. For example, a small hole through an exterior wall into a burning compartment can be safely made from outside of a structure. Then, the wand tip can be inserted through the hole and the handle end of the wand lowered. This raises the lighter end of the wand tip. If the wand end is inserted into the interior compartment, then the handle is lowered, the wand tip will rise and interfere with the top of the hole through the interior wall finishing surface. By then gently pulling backward on the wand handle the wand barrel will slide backward until the catch 112 encounters the inner wall face.

At this point the wand valve can be locked on (the lock not shown) so that the spray continues. This performs the function of filling the compartment with vapor and shutting down the flames and heat release rate in the vicinity of the wand insertion. The wand inserted in this manner and locked “ON” performs the function of an ultra-high pressure sprinkler within the compartment.

The fire fighter is then free to go get a second wand and attack the fire from a different location. The hose reel 107 is equipped with a high pressure swivel fluid input 113 on axis that is coupled to the hose internally. One such connection is shown, the water or fire suppression fluid. A second connection can optionally be connected to the opposite side of the hose reel to deliver breathable air within a second hose and the hose to the fire suppression tool can be a dual hose in that case.

The battery 111 shown can optionally also power an electric drive motor to propel the vehicle, or another separate battery can be used to propel the vehicle.

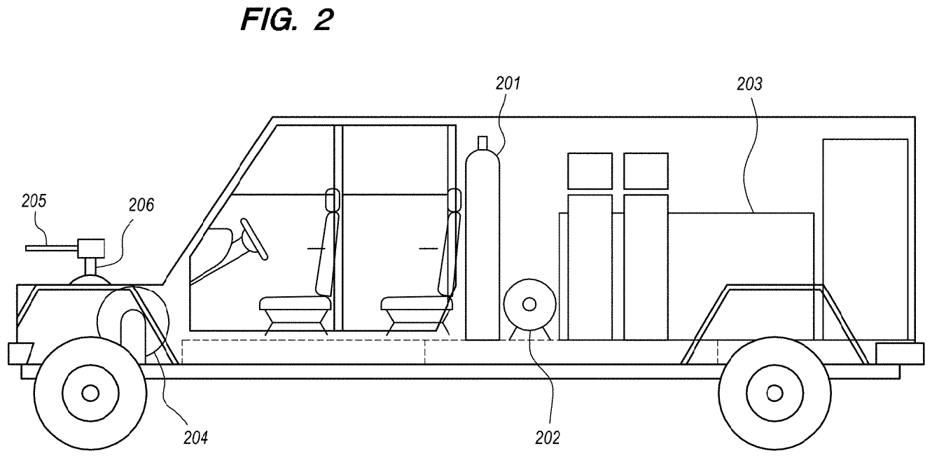

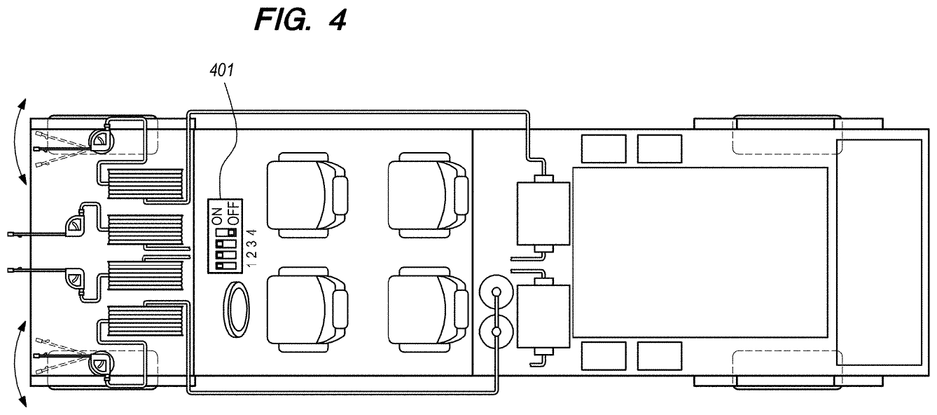

FIG. 2 shows a crew cab of the vehicle, a gas bottle 201 for breathable air, a UHP fluid pump 202, the reservoir 203, on the front a hose reel 204 and a fire suppression tool 205 mounted on a turret 206. A switch 401 to energize the fluid suppression system is shown on FIG. 4. The turret is directable via controls, see FIG. 8, mounted within the vehicle so that a fire outside the vehicle can be fought from within the safety of the vehicle if desired. For example, in the case of a tunnel fire it may be advantageous to attack the fire from within the vehicle crew cab, at least initially.

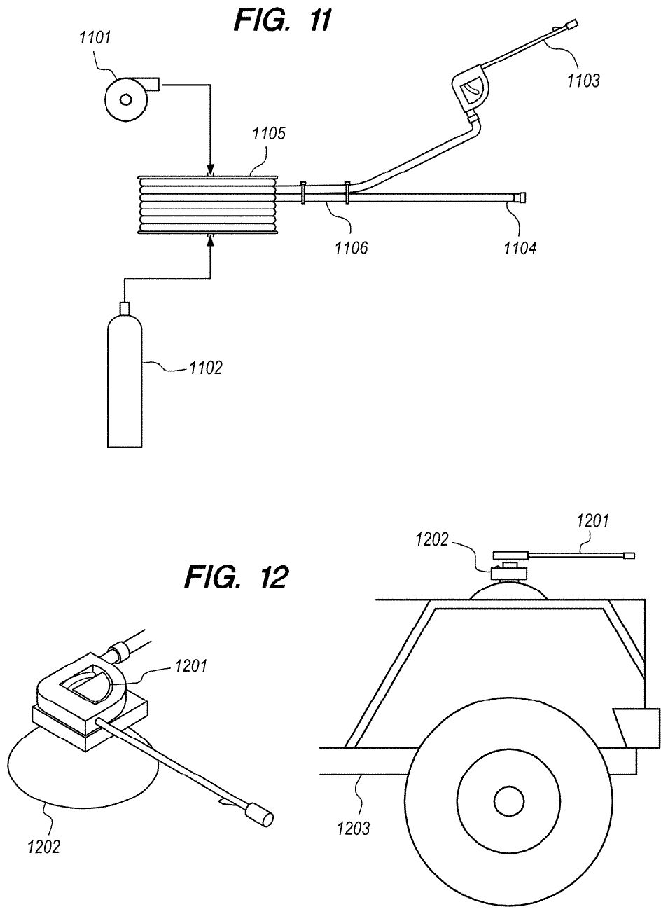

The wand 205, shown mounted onto the turret 206, can be removed by unlatching a hand actuatable latch, see FIG. 12. There is an electric switch on the mount the condition of which changes depending on whether the fire suppression tool is mounted onto the turret, or removed from the turret. The switch enables the motor controller to modify its behavior depending on whether the tool is being used on the turret, or it is being used by a fire crew as a hand spray.

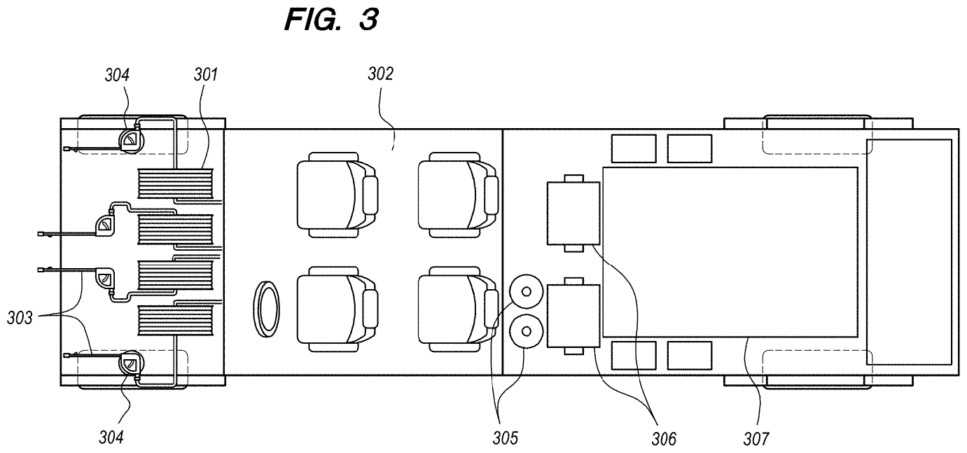

FIG. 3 shows a plan view that includes four hose reels 301 preferably mounted forward of the crew cab 302 and four fluid output tools 303 also preferably mounted forward of the crew cab. Typically, other fire vehicles place the fluid output tools for UHP systems on skids or in compartments to the rear or sides of the vehicle. This requires fire crew to move backward to get a fluid delivery tool prior to moving forward toward the actual fire. With the tools and hose reels mounted forward of the crew cab, the crew need only move toward the fire once exiting the vehicle and the vehicle can drive directly toward the fire and park. This enables use of the turret sprays 304 whenever the fire is ahead of where the vehicle parks, and it enables the use of turret sprays for brush and grass fires on the side of the vehicle while the vehicle is moving.

An optional aspect of the example emergency response vehicle is the inclusion of an On/Off switch 401 to energize and de-energize the fire suppression system while the vehicle is in motion and preferably prior to arrival at the fire scene. Energizing the fire suppression system prior to arrival can save two minutes time to first water on the fire post arrival.

A typical fire engine requires first to park the vehicle. Then crew need to go turn on and energize the fluid pump system. This often means putting the fire engine into a parked condition and shifting the engine power to a power take off PTO that then powers the water pump. Meanwhile, crew need to get the lay flat hose off the truck and spread it around on the ground in preparation for water flow. Finally, water is delivered and fills the lay flat hose and crew can begin to battle the fire. All of these activities take two to three minutes on a typical fire engine. In contrast the new fire vehicle, with a switch located within the crew cab, enables the fire crew to energize the fire suppression system prior to arrival on scene. While the vehicle driver is parking and shutting down the vehicle, the remainder of the crew can immediately exit the vehicle, grab a fire suppression tool and walk directly to the fire. The first flow of water can be delivered within about ten seconds with the new vehicle and its features compared to two or three minutes for a standard fire engine.

In this example, there are two bottles of air 305 and two UHP water pumps 306 shown as well as the plan view of the large reservoir 307. The switch to energize the fluid pump system, located within the crew cab, is not shown (see FIG. 4 & FIG. 8).

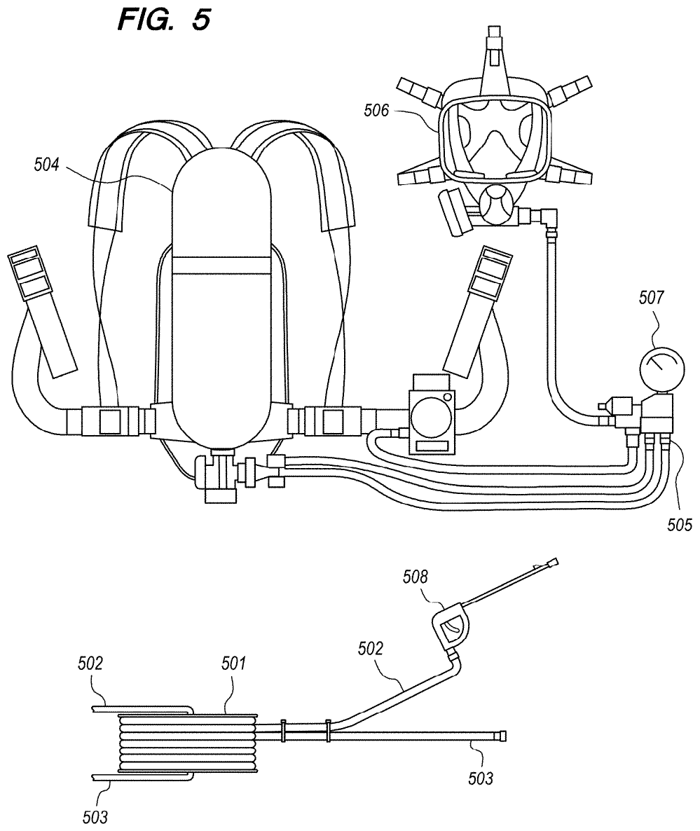

FIG. 5 shows a view of a hose reel 501 comprised of a pair of hoses for fire suppression fluid 502 and for breathable air 503. It also shows a typical air bottle 504 with a hose connection to a component 505 to deliver air to the fire crew mask 506 through a slightly positive pressure mask interior pressure regulator 507. The reel is shown with one hose 502 going to the fire suppression tool 508 that carries the fire suppression fluid, typically water, as well as a second hose 503 that is not connected. If the fire crew were carrying all of these components the system is shown in the configuration where the crew is breathing air coming from the air bottle.

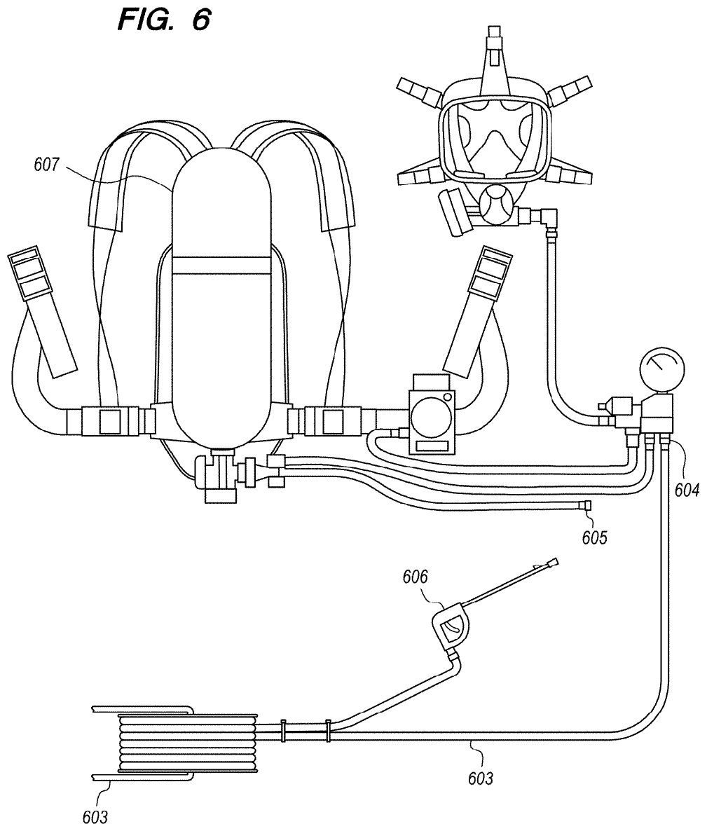

FIG. 6 shows essentially the same view as FIG. 5. The difference is that the air hose 603 from the fire vehicle is connected to the mask breathing system regulator 604 and the air hose from the air bottle 605 is disconnected. Current technology does not have the dual hose lines. For this reason, the supply of air to the mask comes from the air bottle. Because this is a finite and small supply of air, carrying a larger bottle is desirable. However, a larger bottle weighs more and costs more. The heavier bottle results in increased fire crew fatigue during a fire fight. The example embodiments of the emergency response vehicle enables fire crew to carry a small bottle of air and to use that only in an emergency situation where the crew must abandon the wand 606 with the air supply hose 603.

Normally, the fire crew will connect the air supply line as shown in FIG. 6, and they will use a very small bottle of air to reduce weight. Most of the time, the fire crew will carry out their entire fire suppression fight using only air from the large bottles on the fire vehicle. The backup air, to be used, requires only that the quick disconnect fitting 604 from the vehicle be disconnected, and in its place, the similar hose 605 from the reserve air tank be connected. This switch of air supply will take about five seconds. Once the crew have switched to reserve air they have a period of time dependent on the size of bottle they carry, same as has always been the case. However, that period of time will typically never be used since the fire vehicle large bottles can be sized to be more than able to provide air for the entire vehicle crew throughout multiple fire suppressions in a single day.

This advantage can save lives in cases where a fire crew becomes trapped in a structure. It is unfortunately the case that fire crew work until their bottles of air run out, keeping a reserve at all times. But when a crew becomes trapped and a May Day call is given, the crew might be stuck or pinned beneath fallen structural materials. It happens from time to time that it takes longer to extract a fire fighter than that fire fighters air lasts, and the crew suffocates in spite of not being in a dangerous location as far as fire is concerned.

Having primary air from the fire vehicle enables nearly unlimited time to extricate a fire crew in cases where the fighter becomes trapped, dramatically improving survival chances. And for cases where the hoses became trapped, the fire crew can abandon the fire suppression tool and air supply hose, connect to their fresh bottle of air on their back 607, and exit a dangerous situation.

FIG. 7 shows a typical fire scene where a fire has fully engulfed a compartment of a structure 705. A wall 707 separates the fire compartment from a safe non fire area depicted by the exterior of a structure 704. The exterior of the fire compartment could equally be a different room within a structure that is separated from the fire compartment by a wall or a floor or other object behind which fire crew can attack the fire. To do so the crew can, with the current invention, punch a hole 703 through the wall 707 and then insert the fire suppression tool 701 through the hole.

By tilting the heavy end of the tool with the fire suppression fluid trigger 706 and hose 709 downward, the tip end of the wand is tilted upward enabling the wand tip catch 702 to interfere with the interior wall. By then compressing the wand trigger 706 the spray is emitted 708 into the fire compartment. Optionally the trigger can include a lock to lock the trigger in the ON position so that the fire crew can set the wand, turn on the spray, and then leave the wand alone to continuously spray mist into the fire compartment while the fire crew can go perform some other task.

As the fire suppression fluid mist interacts with the hot gases and flames within the fire compartment, the water droplets will vaporize and absorb energy. In so doing, they will expand up to 2,000 times in volume. This expansion displaces the gases in the fire room and replaces them with, typically, inert water vapor. It doesn't matter very much where the mist is directed. Everywhere inside of the fire compartment is inside of the fire compartment and will vaporize and push gases out of the room. This action impedes the entry of fresh oxygen to feed the fire and as a result, the addition of mist into the fire compartment has the action of suffocating the fire.

The fire is suffocated within the fire compartment, but it is also suppressed outside of the fire compartment as cooler gases exit the compartment to interfere with fresh oxygen entering the fire structure from the outside. Remember that flames suffocate when the oxygen concentration drops to below 15% oxygen, from normal atmospheric concentration of 21% oxygen. However, humans do not suffocate at 15% oxygen concentration and at any rate, modern fire crew are equipped with breathing apparatus so that the reduced oxygen concentration helps fire crew by reducing the temperature of the gases they experience.

FIG. 8 shows an exemplary remote control 801. It includes a joy stick to direct the turret(s) on the fire vehicle, a selector to choose which turret spray to control, and on off switches to control the fluid delivery systems and pumps so that they can be energized using the remote control, prior to arrival at a fire scene. Duplicate On/Off switches can be included within the crew cab of the fire vehicle.

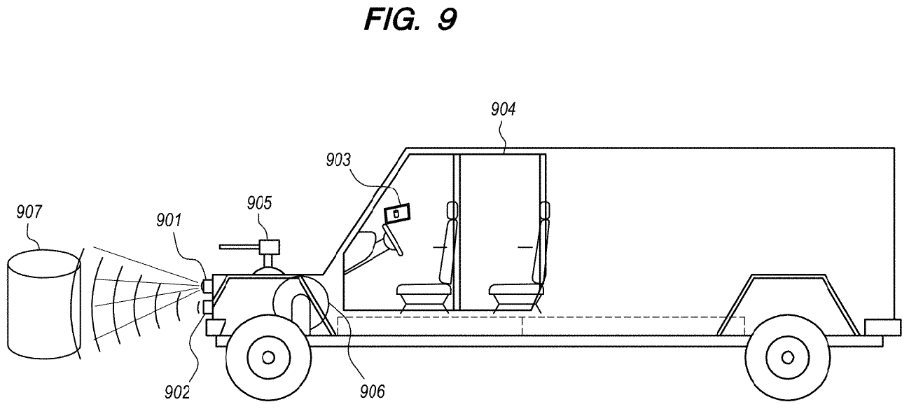

FIG. 9 shows an elevation view of a typical fire vehicle fitted with UHP fire suppression systems. The crew cab 904 is fitted with a display 903 that displays images captured by the exterior vision system 902. This system can be an optical camera, an infrared camera, an ultrasonic phased array detector, a radar detector or other vision system. A single vehicle could be fitted with multiple vision systems to provide feedback to the fire crew under different conditions.

Infrared cameras are, for example, excellent at indicating where the environment is hottest and this helps direct the fire suppression fluid flow from the turret 905 and also provides a visual feedback to how the fire suppression fluid is cooling the environment around the vehicle. However, in cases where there is smoke too thick for infrared to see through, it will be advantageous to include an ultrasonic or radar based detector capable of seeing through thick smoke to guide the vehicle into the darkness to the fire scene.

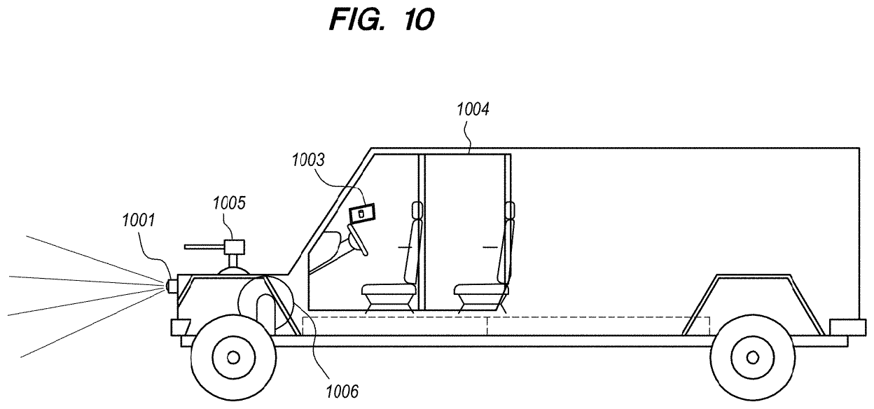

FIG. 10 is similar to FIG. 9. The emitter 1001 could be an ultrasonic or radar emitter, a phased array of ultrasonic or radar emitters, or a speaker broadcasting to any people trapped in the smoke filled space, or other emitter as will become obvious upon further study of the rescue vehicle potential. Also shown is an object 907 represented by a barrel. The object could of course be a human laying on the ground or any objects that might result from a vehicle crash within a tunnel. An emitter, such as an infrared light 901 is shown. By emitting light detectable by the sensor, it is possible to enhance the image displayed in the cab.

FIG. 11 shows a simplified lay out of the fire suppression system of dual hoses. On one side of the hose reel 1105 there is a UHP fire suppression fluid pump 1101 that delivers typically water into the center swivel connector of the hose reel on the axis of rotation. The fire suppression fluid is delivered into one of two hoses that connects to the fire suppression tool 1103. Breathable air, from a bottle 1102 on the fire vehicle can optionally connect to the second side of the hose reel. In this configuration, the hose on the reel is a dual hose with the first hose carrying the fire suppression fluid to the fire suppression tool 1103. The second hose on the reel 1106 comes from an air supply on the vehicle, here represented as a bottle 1102. The bottle could instead by a compressor or multiple bottles. The hose terminates with a fitting 1104 at the end of the hose. The fitting is designed to connect to the fire crew breathing system, for example, to the regulator 604.

FIG. 12 shows a perspective view of the fire suppression tool mounted onto a turret 1202. The elevation view shows the fire vehicle 1203, the turret 1202, and the fire suppression tool 1201. When mounted onto the turret, the fluid spray is controlled by modulating the UHP pump on and off. To realize this function it is necessary for the fire suppression tool trigger 1205 to be locked in the ON condition. One way to realize this is to include a block of material 1204 that interferes with the trigger such that the trigger is forced into the ON condition whenever the fire suppression tool is mounted onto the turret.

Not shown is an electrical switch, for example a single pole double throw button switch or other proximity sensor that detects when the wand is mounted onto the turret. This switch informs the fluid control system that the fire suppression tool is either mounted onto the turret, or, removed and being used to fight a fire by a fire crew. When mounted, the spray is modulated on and off by modulating the UHP pump on and off. When removed and being used by a fire fighter via the hand actuated trigger, the UHP pump control system will increase the UHP fluid pressure in the line until it is at the pre-determined line pressure. When the pressure exceeds this set point pressure, the UHP pump will turn off and maintain the line pressure until the trigger is pulled by the fire crew as they fight the fire.

The electric switch, therefore, is used to change the programming protocol from one where the pump is modulated to flow fluid, to one where the pump maintains a fixed line pressure and a human modulates the trigger on the fire suppression tool.

The spray wand includes a trigger to regulate the UHP flow between 0% to 100% of the flow capacity of the high pressure pump system. The vehicle preferably includes a mount for at least two wands on the front of the vehicle ahead of the driver of the vehicle. This way the driver can drive directly toward a fire and park the vehicle with the wands already directed toward the fire location, whether that be a car or a structure or other type of fire.

Preferably the at least two wands will mount onto a turret on the front of the vehicle. The turrets are preferably controllable from inside the vehicle so that fluid can be sprayed onto the fire even before the fire fighters exit the vehicle. The fluid jets can preferably be turned on as the vehicle approaches the structure and before the vehicle parks, decreasing the time to first fluid application by a few additional seconds compared to fire engines and UHP pickup trucks which must first park and then turn on the fluid pump and then deploy the hoses and so on.

The wands can be used while attached to the turrets via remote controls if desired. Or, the wands can be removed from the turrets and pulled toward the fire. A typical hose reel will have 200 to 300 feet of high pressure hose. Typical hose diameters are from ½ inch to 1 inch with ½ inch being common. But these diameters are not limiting and larger diameters could be deployed if a mount was created to resist the reaction thrust of the fluid ejection at high pressure. A larger line diameter could be deployed to a larger fire and then attached, at the end, to a simple support to help the fire fighter resist the reaction thrust.

The wands can be removed and the hose pulled out by the fire fighter so that the wand can be used to enter a structure the same as a standard 1.5 inch diameter hose line. In some aspects, the turret mounts enable fire fighters to battle a fire within a tunnel filled with toxic gases while remaining safely inside of the vehicle by means of using the turret sprayers and by simply driving the fire vehicle directly toward whatever happens to be on fire within the tunnel.

The ability to have the hoses ready to immediately deploy from the front of the vehicle is an aspect of the example embodiments of the emergency response vehicle. The ability to charge the hoses prior to arrival at the incident scene and indeed, to shoot fluid spray at a fire while driving, is an aspect of the example embodiments of the emergency response vehicle. This enables the system to also be used to fight grassland and forest fires by shooting spray while driving.

For tunnel operations the vehicle and the fluid pumps will preferably be powered using electricity from a battery energy storage system. Electric vehicles (EVs) are able to drive into oxygen deprived atmospheres and smoke laden air without a problem. And electric powered fluid pumps are able to flow fluid in spite of there not being enough oxygen in the tunnel to support the operation of an internal combustion engine (ICE) powered fluid pump. Therefore, for tunnel operation it will be preferable for the vehicle and pump to both be powered using energy stored in a battery.

Providing at least one and preferably two or four UHP wands at the front of the vehicle reduces the time required to drag the hose around a vehicle and allows the vehicle driver to drive straight at the fire and park.

It is possible for one fire fighter to take 2 hoses to a fire structure. A first hose can be inserted into a hot fire space to function as a UHP spray to suffocate the fire within the structure. This is accomplished by punching a hole through a wall, inserting the tool, locking the spray on, and leaving that tool to suppress the fire in that part of the building. The second hose can then be used to aggressively attack the fire or to insert a second UHP fluid spray into another fire compartment space. Thus, a single fire crew can effectively utilize more than one single hose and tool. Indeed, a single fire crew, operating alone from outside a structure, could effectively deploy 4 fire hoses into 4 different compartments to suffocate an interior structure fire. Having the tools and reels on the front of the vehicle makes the deployment of multiple tool lines into a structure easier for a single fire crew to realize.

Otherwise, with other systems that have the hose reel on the rear of the vehicle, it requires either that the hose be dragged sideways around the vehicle or that the vehicle take the time required to back into a location that points the rear of the vehicle toward the fire. This improvement saves about 30 seconds time in putting first fluid on the fire. And for tunnel fires where backing toward the fire is impossible, having the hoses deploy from the front of the vehicle is critical to function.

Beyond the time saved, when a pair of fire fighters enter a building with two wands, they can of course fight the fire. But they can also, in an emergency, spray each other with their wands. The fluid blast from a 150 gallons per minute (gpm) hose is too intense to use this new strategy. But with UHP systems, crew can cool each other with the fluid mist spray in an emergency such as when fire crew are suddenly in the fire flow path. In this way they have a way to cool themselves in the rare event that they become trapped in the fire flow path.

This is what has killed numerous fire fighters in the past, and without a pair of hoses that spray a fine mist that will not knock each other down, spraying each other has never been an option with conventional fire hoses delivering 150 gpm of fluid. It is also not an option for the existing pickup trucks that carry a single UHP line to slow the fire growth until a fire engine arrives.

Conventional fire hoses deliver 150 gpm at low (e.g., 100 psi) pressure in a more or less solid stream flow. Even so-called fog nozzles create a spray of droplets of dramatically larger size. About 95% of the fluid delivered from conventional nozzles falls to the floor to cool burning materials. Perhaps 5% of the fluid is boiled to steam, however, most of that steam is generated as the large fluid droplets hit hot materials that are burning. The conventional attack method is to cool down the burning materials. When the hot materials are cooled, the fire intensity is reduced. The current conventional wisdom is that to extinguish a fire one must cool the burning materials and as a result, the fluid delivery is optimized to realize this goal.

UHP systems work in a completely different way. For UHP systems, the fluid droplets are smaller and so a greater volume are vaporized and this removes energy from the fire, thus cooling it as UHP advocates have correctly identified. There is some mention that the droplets also displace oxygen by some. However, it is generally believed that the reason UHP systems work so well is because they more rapidly cool the fire space. In every instance the belief exists that the function of the finer mist of fluid spray is to better cool the fire so that it can be suppressed. This is the same logic as is used for conventional fire-fighting: cool the fire until the materials are no longer burning. This understanding is incorrect and as a result the reasoning ascribed and methodologies taught are also below optimal.

UHP systems work by a different mechanism than do conventional fire hoses. UHP systems are better thought of as “Directed Inert Gas” fire suppression systems. Inert gas systems function by reducing the oxygen concentration to below 15% in the volume of flames. Flames will not burn smoke particulates whenever the oxygen concentration drops below around 15%. As a result, the flames are extinguished. But this does not cool the burning materials and if the oxygen deprived materials and smoke were allowed to receive new oxygen, they would re-ignite.

To understand the way UHP functions it is useful to understand the cooling power of fluid delivery. The cooling power of a 150 gpm line is about 15 megawatts (MW) if all of the fluid were vaporized. Thus when fighting a 20 MW structure fire the conventional hose line is deemed on a par with the heat release rate (HRR) of the fire. In contrast, a UHP line with 20 gpm fluid delivery carries a cooling power of just 2 MW. Based on this metric one would conclude that the UHP flow could never knock down a 20 MW fire. It is observed, however, that within 5 to 10 seconds, a UHP spray does in fact knock down a 20 MW fire. This seems impossible and witnesses are amazed by how well it works. However, they do not understand why it works and as a result, they do not understand how best to deploy this new system of fire suppression.

Simple math indicates that 20 MW−2 MW=18 MW and the heat generated by the fire would continue to grow as if no fluid were being delivered. And yet a 20 gpm=2 MW cooling power is clearly able to suppress a fire of approximately 20 MW (e.g., as shown in https://www.youtube.com/watch?v=x9pYbsNSCZE&t=97s). Frame by frame analysis of this ˜15 MW fire indicates that the flames inside the garage are extinguished, twice, following about five to ten seconds of fluid flow inside of the garage. The first flame out happens when the fire fighter first flows the spray into the interior for approximately 7 seconds. Then, spray is directed across the outside of the garage to extinguish flames there for the next several seconds. During those seconds, fresh air with new oxygen re-enters the garage and the flames burst back into existence. This establishes that while the UHP spray was able to extinguish the flames, it did not put out the fire or cool the interior to below ignition temperature.

Then, after another five to ten seconds of flow back into the garage, the flames are out a second time. Following that, the spray is continuously flowed into the garage for another minute or so. During this phase the flames remain extinguished and the interior temperature of the surfaces is cooling down. This is evidenced by the increasing steam condensation of the gases flowing out of the garage. The transition from superheated (transparent) steam to saturated vapor (white billowy steam) is easily observed over the course of the video.

“Cooling” is not the reason UHP systems work, because at just 2 MW the cooling power is far less than the HRR of this and other fires where UHP has been tested. UHP works because the fine spray of droplets is able to float around within the fire zone and to completely vaporize. This delivers 2 MW of cooling power to the gases in the compartment, but not to the burning materials. This is the opposite of what a typical 150 gpm hose line does. For a two car garage sized room, it takes approximately 5 seconds of a 20 gpm fluid flow being fully vaporized to reduce the oxygen concentration within the room from 21% down to below 15%. Fire flames cannot exist when the oxygen concentration drops below 15%.

Rather than cool the hot burning stuff to suppress the evolution of combustible pyrolized gases as 150 gpm hoses do, the UHP system works differently. It shuts down the 20 MW HRR by suffocation as a result of the fluid vapor dropping the oxygen concentration within the fire room. Normal atmospheric oxygen concentration is 21% and flames are extinguished if the concentration is reduced to below about 15%. As soon as the 20 MW of heat release is eliminated, in five seconds or so, then the 2 MW of cooling power becomes significant. Suffocation causes the 20 MW Heat Release Rate to drop to 0 MW within seconds in a compartment the size of a two car garage.

Following the flames being extinguished, continued flow of the high pressure fluid spray provides 2 MW of cooling power that quickly drops the temperature of objects and gases within the fire compartment to around 212° F. or below. During this cooling process, the vaporization of the water spray is absorbing energy and also maintains a low oxygen concentration that precludes the pyrolized gases from oxidizing and releasing energy. Conduction between the hot burning materials and the cooler ambient gases then cools the hot materials until their temperature is below 451° F., the temperature at which typical materials ignite.

This cooling happens while maintaining an oxygen concentration below 15% so that the HRR remains suppressed during this cooling phase. Once the structure contents are cooled to below 451° F. ignition temperature, for example once they are cooled to around 212° F., the boiling temperature of water, re-ignition becomes impossible and the structure fire is considered to be extinguished.

As can be seen, it takes about another 60 seconds of flow, after the flames and HRR are eliminated, to cool the interior materials to below ignition temperature at the end of the video. The point is that it is easy to drop the oxygen concentration within a large volume, while it is extremely difficult to actually hit all of the burning materials with 150 gpm fluid hoses. Often, the fluid cannot reach the burning materials inside of a structure. But a fluid mist can easily be flowed into a volume of a compartment where fire exists to drop the oxygen concentration.

By putting one or preferably four UHP systems onto a single vehicle, it becomes possible to replace a typical fire engine with a superior fire suppression vehicle at perhaps one quarter the cost. This enables departments to increase the number of vehicles they have without increasing their budgets. The emergency response vehicle of the present disclosure may enable a smaller, faster vehicle that includes a superior fire suppression system that requires a lower volume of fluid to knock down a fire.

Typically, the smaller vehicle can get to a fire scene in about two minutes shorter time. Then, it takes seconds to deploy the UHP fire lines compared to another two minutes to get fluid into the hose lines of the normal fire engines. And the UHP system uses about one-fifth the fluid of the conventional fire energy systems. After depleting a 320 gallon reservoir, simple garden hose lines could supply enough fluid from the local or next door garden fluid supply to continue a fire fight indefinitely.

However, due to the ability of the UHP system to suffocate the fire, the fire can be extinguished even around a corner within a structure. This is not possible with conventional fire hoses. If the fluid can hit the burning materials, it can extinguish them. But if the fluid spray is hitting across a room or around a corner from where a fire is burning, then the fire just keeps on burning. It is often the case that a fire attack cannot be waged until after the fire burns a hole through the roof to allow ladder nozzles to shoot thousands of gallons of fluid into the structure interior through the gaping hole in the roof. By this time, of course, the entire structure is basically a loss.

The ability of UHP to suffocate a fire is poorly realized today and reason for replacing or augmenting all existing fire engines with multiple UHP lines. But from the perspective of this particular disclosure, the proposed UHP rapid attack fire vehicle can get to a fire faster than an engine, deploy hoses and initiate fluid delivery to the fire faster, and using suffocation, knock down a fire faster than can a conventional fire engine. The emergency response vehicle of the present disclosure can get to a fire about one or two minutes faster than a conventional fire engine, depending on distance and routes. The emergency response vehicle can deploy fluid hoses and get the first fluid onto the fire in about 1.5 minutes less than a typical fire engine. And, the emergency response vehicle can often shut down a fire in less than one or two minutes that can take a conventional fire engine 30 minutes to suppress.

The time savings happens in part due to the more rapid fluid delivery. But in significant part the fact that fluid is delivered more quickly during the rapid growth phase of the fire, means that the fire is suppressed before it grows to the size at which a conventional fire engine typically begins delivering fluid. The emergency response vehicle using UHP fluid delivery attacks smaller fires than do existing engines because they get fluid onto the fire faster, before the fire has grown.

In some aspects, the emergency response vehicle is arranged with a pair of wands located at the front of the vehicle so that the vehicle can drive directly toward the fire, park, and begin shooting fluid. No backing up may be required. And within roadway conduit tunnels, a key attribute is having the vehicle and fluid delivery system powered by electric power instead of internal combustion engines that cannot run in a reduced oxygen environment. For the majority of fire-fighting, ICE powered vehicles and fluid pumps will suffice, but for tunnel duty the vehicle and fluid suppression devices will preferably be fully powered by zero-emissions power sources.

Another attribute specific to the disclosed emergency response vehicles for roadway conduit vehicles is the addition of infrared and ultrasonic vision systems to enable the driver to advance down a tunnel in spite of the tunnel being filed with thick black smoke making visual navigation impossible. With thick smoke, visual navigation is impossible as it can be the case that one cannot see further than a few inches through the thick smoke. To drive into such an environment, therefore, it is important to have a different “vision” system than optical. Infrared cameras can see further through smoke but even they can be blocked if the smoke is thick enough. Ultrasonic sensors, however, can “see” perfectly well through any thickness of smoke. Preferably, an array of ultrasonic sensors will be used to create a phased array or another configuration of an array of emitters and sensors that can create at least a rudimentary image that includes the walls of the tunnel as well as objects, including people that may be collapsed on the road base. It is not necessary to see with the clarity of normal vision, but it is necessary to be able to see well enough to guide the vehicle to the location of the fire so that the fire can be suppressed and victims can be rescued.

In example implementations, an emergency response vehicle according to the present disclosure may include one, some, or all of the following features: zero emissions drive and fluid delivery power systems; zero emissions UHP fluid pump with an ICE vehicle drive; fluid pump ON switch in crew cab with ICE power for fluid delivery and vehicle; one UHP hose/wand forward of crew cab with ICE power for fluid delivery and vehicle; two UHP hose/wands on vehicle for team suppression methods; at least one turret mount for wand, forward of crew cab; zero emissions fire vehicle with human eye invisible guidance system; non-human eye visual vehicle guidance to heat source via IR; non-human eye visual vehicle guidance via ultrasonics, lidar, or radar (or a combination thereof); vehicle “Follow Me” autonomous movement function; vehicle IR vision on front, autonomously directed turret and fluid flow; fluid pump motor rotational speed (e.g., rpm) follows fluid line pressure, keeping fluid pressure within a range, including 0 rpm when the fluid pressure remains within the pre-determined range when line fluid flow is at or near zero; zero emissions emergency response vehicle with IR headlamps.

A number of implementations have been described. Nevertheless, it will be understood that various modifications may be made without departing from the spirit and scope of the disclosure. Preferably a vehicle will have several firefighting tools and hoses, though while we have shown examples where 4 hoses and tools are used, a vehicle could optionally carry just a single pump, hose, reel, and firefighting tool, with or without an air bottle and dual hose fluid supply. For example, example operations, methods, or processes described herein may include more steps or fewer steps than those described. Further, the steps in such example operations, methods, or processes may be performed in different successions than that described or illustrated in the figures. Accordingly, other implementations are within the scope of the following claims.

1. A zero-emissions emergency response vehicle, comprising:
at least one zero-emissions power system;
at least one drive assembly coupled to the at least one zero-emissions power system and operable to move the vehicle with power from the at least one zero-emissions power system; and
at least one ultra-high pressure (UHP) fluid delivery system mounted to the vehicle and comprising:
a fluid reservoir mounted to the vehicle and configured to store a fire-suppression fluid,
a fluid output tool fluidly coupled to the fluid reservoir, and
at least one UHP pump-motor assembly coupled to the at least one zero-emissions power system and operable to circulate a flow of the fire-suppression fluid from the fluid reservoir to the fluid output tool with power from the at least one zero-emissions power system.

2. The zero-emissions emergency response vehicle of claim 1, wherein the at least one UHP pump-motor assembly is electrically coupled to the zero-emissions power system to directly receive electrical power from at least one electrical power storage device of the at least one zero-emissions power system.

3. The zero-emissions emergency response vehicle of claim 2, wherein the at least one electrical power storage device comprises a battery.

4. The zero-emissions emergency response vehicle of claim 1, wherein the UHP fluid delivery system further comprises a UHP fluid line pressure control system configured to perform operations comprising modulating rotational speed of a motor of the at least one UHP pump-motor assembly to maintain a predetermined fluid line pressure.

5. The zero-emissions emergency response vehicle of claim 4, wherein the UHP fluid line pressure control system is configured to perform operations further comprising:
determining that a fluid line pressure of the fire suppression fluid is less than the predetermined fluid pressure; and
based on the determination, increasing the rotational speed of the motor up toward a maximum allowable rotational speed of the motor.

6. The zero-emissions emergency response vehicle of claim 4, wherein the UHP fluid line pressure control system is configured to perform operations further comprising:
determining that a fluid line pressure of the fire suppression fluid is greater than the predetermined fluid pressure; and
based on the determination, decreasing the rotational speed of the motor down toward, and inclusive of, zero rpm.

7. The zero-emissions emergency response vehicle of claim 1, further comprising at least one switch positioned in the vehicle and communicably coupled to the at least one UHP fluid delivery system, the at least one switch adjustable between an off position to de-energize the UHP pump-motor assembly and an on position to energize the UHP pump-motor assembly.

8. The zero-emissions emergency response vehicle of claim 7, wherein the at least one switch is operable in the on position to energize the UHP pump-motor assembly independent of operation of the at least one drive assembly.

9. The zero-emissions emergency response vehicle of claim 7, wherein the at least one switch is located on a portable remote control.

10. The zero-emissions emergency response vehicle of claim 1, further comprising a human-occupiable crew cab.

11. The zero-emissions emergency response vehicle of claim 10, wherein the at least one UHP fluid delivery tool is stowed on the vehicle forward of the crew cab.

12. The zero-emissions emergency response vehicle of claim 10, wherein the at least one UHP fluid delivery system further comprises a hose reel coupled to the fluid outlet tool, the hose reel positioned on the vehicle forward of the crew cab.

13. The zero-emissions emergency response vehicle of claim 1, further comprising a vision system configured to perform operations comprising:
detecting one or more objects located near to the vehicle; and
providing a visual indication of the detected one or more objects within the crew cab.

14. The zero-emissions emergency response vehicle of claim 13, wherein the vision system comprises an infrared camera and one or more infrared illuminating lights operable to emit infrared light away from the vehicle.

15. (canceled)

16. (canceled)

17. The zero-emissions emergency response vehicle of claim 13, wherein the vision system comprises at least one ultrasonic transceiver configured to determine a distance between the vehicle and at least one external object.

18. The zero-emissions emergency response vehicle of claim 1, further comprising a human-breathable compressed air system in fluid communication with the hose reel.

19. The zero-emissions emergency response vehicle of claim 18, wherein the hose reel comprises a hose pair that comprises:
a first hose that communicates the fire suppression fluid from the fluid reservoir to the fluid output tool; and
a second hose that communicates a pressurized human-breathable gas from the human breathable compressed air system to an output located near the fluid output tool.

20. The zero-emissions emergency response vehicle of claim 2, further comprising:
a vehicle drive system that comprises one or more wheels driveably coupled to an engine.

21. The zero-emissions emergency response vehicle of claim 20, wherein the engine comprises an internal combustion engine.

22. The zero-emissions emergency response vehicle claim 20, wherein the engine comprises a generator electrically coupled to the at least one zero-emissions power system to electrically charge the at least one electric power storage device of the at least one zero-emissions power system.

23. (canceled)

24. (canceled)

25. (canceled)

26. (canceled)

27. (canceled)

28. (canceled)

29. (canceled)

30. (canceled)

31. (canceled)

32. (canceled)

33. (canceled)

34. (canceled)

35. (canceled)

36. (canceled)

37. (canceled)

38. The zero-emissions emergency response vehicle of claim 10, wherein the human-occupiable crew cab is mounted to a chassis, and
the vehicle drive system is mounted to the chassis.

39. (canceled)

40. (canceled)

41. (canceled)

42. (canceled)

43. (canceled)

44. The zero-emissions emergency response vehicle of claim 1, further comprising:
at least one directable turret mount, mounted onto the vehicle and configured to securely hold the fluid output tool independent of vehicle movement and independent of whether the tool is or is not spraying the fire suppression fluid, and where the turret mount is comprised of a fluid output tool latch that is hand operable to securely hold the fluid output tool onto the vehicle when latched, and to release the fluid output tool for removal by hand when the latch is unlatched, and at least one turret controller that controls the turret pointing of the turret and the flow of fire suppression fluid through the fluid output tool when mounted onto the turret.

45. The zero-emissions emergency response vehicle of claim 44, wherein the turret mount includes a detent to lock the fluid output tool hand valve in the open position while the fluid output tool is mounted onto the turret.

46. The zero-emissions emergency response vehicle of claim 44, wherein the turret mount includes an electro-mechanical switch that is electrically changed from a first electrical condition when the fluid output tool is mechanically removed from the turret to a second electrical condition when the fluid output tool is mechanically installed and latched onto the turret

47. (canceled)

48. The zero-emissions emergency response vehicle of claim 44, wherein the turret control is in electrical communication with the UHP fluid delivery system and where the UHP pump assembly varies the fluid flow through the fluid output tool based on a signal received from the turret control.
